(19) United States
(12) Patent Application Publication
(10) Pub. No.: US 2008/0059604 A1
(43) Pub. Date: Mar. 6, 2008

(54) Data transfer between a business intelligence system to a bank analyzer system

(76) Inventors: Lutz Brunnabend, Walldorf (DE); Klaus Akemann, Mauer (DE); Markus Roeckelein, Angelbachtal (DE); Stefan Linkersdoerfer, Wiesloch (DE)

Correspondence Address: KENYON & KENYON LLP, 1500 K STREET N.W., WASHINGTON, DC, 20005, US

(21) Appl. No.: 11/514,559

(22) Filed: Aug. 31, 2006

(51) Int. Cl. H04M 11/00; G06F 15/16

(52) U.S. Cl. 709/217; 379/93.05; 709/203; 709/201

(57) ABSTRACT

An apparatus and method for integrating data from a business intelligence system to a bank analyzer system includes the usage of a universal framework. The apparatus and method includes selecting a first data set of denormalized data disposed within the business intelligence system and normalizing the data using the bank analyzer data transfer framework. Once the data is normalized, the apparatus and method further include transferring the data from the framework to the bank analyzer system and populating the data in the bank analyzer system. Through the universal framework, previously denormalized data is integrated into the bank analyzer application allowing for analytical operations to be performed on the data without expensive overhead requirements to get the data between these systems.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relation generally to the transfer of financial data but more specifically to a framework for the transmission of financial data from a business intelligence processing system to a bank analyzer processing system.

In existing business processing systems, specifically financial and banking systems, problems exist regarding the transfer of data between different systems. These business processing systems utilize various components and systems to perform different functions and operations on the data, at different stages. Data formatting from one system can be inconsistent with the needed formatting for different systems, so processing inefficiencies can occur when data is needed between these different systems.

Business intelligence systems are populated with data from various front end systems, typically for reporting purposes. Many business intelligence systems offer sophisticated functionality to import data using diverse load techniques. As these business intelligence systems are optimized for purposes of generating reporting information, the data model in the business intelligence system is denormalized, thereby allowing for the generation of computationally flat tables.

From a user's perspective, the same data also needs to be transferred remotely to the bank analyzer system and/or application so that one or more analytical operations may be performed. For example, the data may be used for a valuation procedure or the determination of financial and risk-oriented key figures. The transfer of this data from the original sources (front end applications) leads to an increase in the number of needed data channels for transferring the data, as well as different data transfer techniques for transferring the data itself. Instead, it is advantageous to transfer the data from the business intelligence system to the bank analyzer system and/or application.

Further problems exist because the formatting is based relative to the usage of the data. In business intelligence systems, the data may have particular structures related to its intended processing purpose. For example, the data may be a data object having sub-classes of information that are used for multi-level processing operations. Although, this financial data is formatted for the specific financial system, but may be utilized by a different analysis system, e.g. a bank analyzer system, for performing computational analysis on the data. The analysis system not only needs the business intelligence data, so the data must be transferred therebetween, but using the data in present format is extremely problematic for the analysis system. The different types of business intelligent systems and the type of data these systems receive and process further complicate these issues.

One existing technique for transferring data is to open multiple data transmission channels to transmit all, or at least most of, the structured data objects in the business intelligence system. For parallel data transfer, n number of channels may be opened, where n is the number of layers or sub-objects of the data object. This technique is very computationally expensive, requiring a significant amount of computational resources to accommodate the large amount of data transfer.

These existing techniques are also limited as being exclusive to the exact business intelligence system and the data format. Therefore, for every different type of business intelligence application or system, a new formatting procedure is required to allow the bank analyzer system to not only receive the data, but for the data to be usable in a position for analytical operations. These data transfer operations are commonly known as extraction, transformation and load (ETL) operations. Different processing systems with different business intelligence applications and banking analysis applications require specific interfaces. It is these specific interfaces that allow for the transfer of data objects therethrough, allowing the banking analysis application to perform its analytical operations. As noted above, these interfaces are extremely time-consuming to generate and are further complicated by their lack of re-usability between different business intelligence applications and banking analysis applications.

### BRIEF DESCRIPTION OF THE DRAWINGS

FIG. 1 illustrates one embodiment of a system allowing for the integration of data from a business intelligence system to a bank analyzer system;

FIG. 2 illustrates a display of components in an ETL process in accordance with one embodiment of the present invention;

FIG. 3 illustrates a processing system in accordance with one embodiment of the present invention;

FIG. 4 illustrates a flowchart of the steps of one embodiment of a method for integrating data from a business intelligence system to a bank analyzer system; and

FIG. 5 illustrates an apparatus allowing for the integration of data from a business intelligence system to a bank analyzer system.

### DETAILED DESCRIPTION

The denormalized data resident in the business intelligence system is usable by the bank analyzer system for various processing operations. One usage of the denormalized data is for reporting purposes which may be done by the business intelligence system and another usage may be analyzing the data to calculate financial risks or other determinative information which is more aptly performed by the bank analyzer system. The transfer of data from the business intelligence system to the bank analyzer is passing this information through a bank analyzer data transfer framework. The framework normalizes the data and through an ETL procedure and provides the data in a usable format to the bank analyzer system. The bank analyzer data transfer framework includes an ETL procedure that is compatible with different business intelligence systems, thereby obviating the usage of inefficient overhead previously required in making data from various business intelligent systems available to the bank analyzer system.

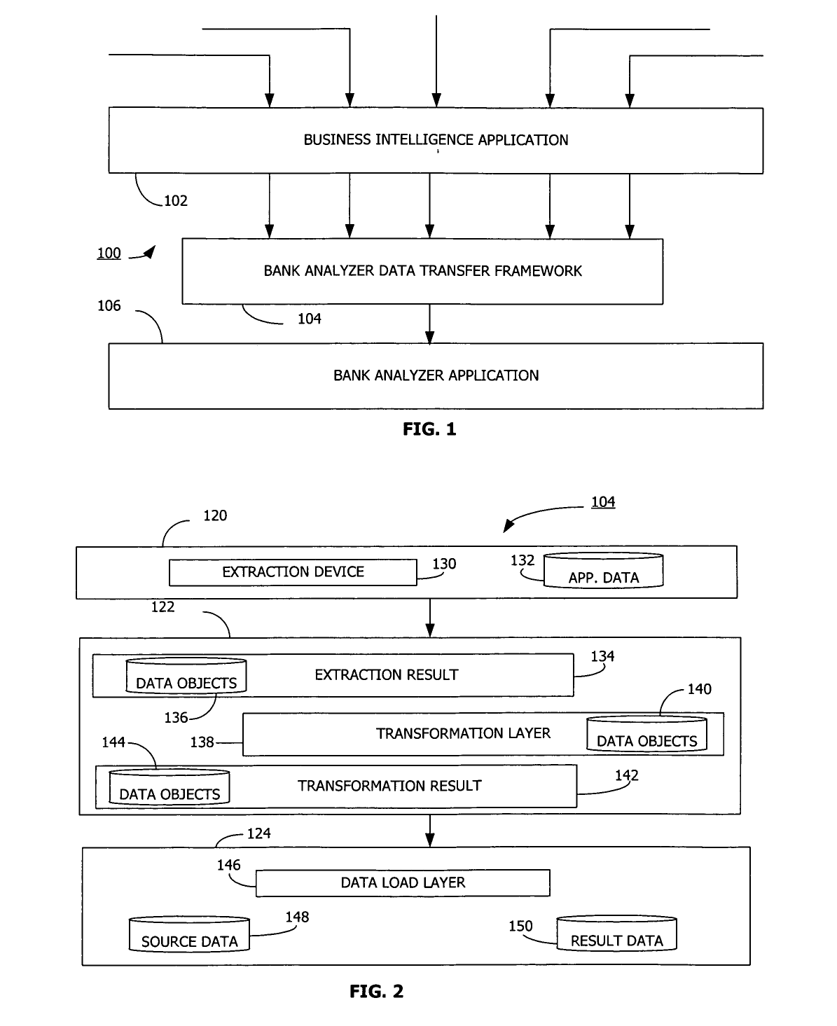

FIG. 1 illustrates a system 100 including business intelligence application 102, a bank analyzer data transfer framework 104 and a bank analyzer application 106. The business intelligence application 102 may be one or more applications, executable on one or more processing devices, for performing business intelligence operations. By way of example, the business intelligence application may be a business intelligence application available from SAP or any other application provider. The bank analyzer data transfer framework 104, illustrated as a separate box in FIG. 1, may be implemented in hardware, software or a combination thereof for performing various processing operations, as described in further detail below. The bank analyzer application 106 may also be implemented in hardware, software or a combination thereof and available to perform various analytical operations as commonly recognized by these analytical processing systems.

In the system 100, the business intelligence application 102 is operative to receive data inputs 108 from various input sources (not shown). In a typical embodiment, the data input may be received from a terminal computing device or other front end processing system. Business intelligence systems that run the business intelligence applications 102 provide various levels of improved productivity, including sophisticated functionalities to import data using diverse load techniques. The business intelligence applications 102 can provide reporting functionalities from the front-end systems. As these business intelligence applications are optimized for these reporting functions, the data models are denormalized.

In the system of FIG. 1, the denormalized data is processed in the business intelligence application 102. Although, further levels of processing functionality may be realized, including analytical operations, such as risk analysis, through processing operations performed by the bank analyzer application 106. As illustrated in the system 100 of FIG. 1, the bank analyzer application 106 receives the data, but it is first passed through the bank analyzer data transfer framework 104. As described above, previous techniques required numerous data channels for sub-levels of denormalized data, but the universal bank analyzer can use existing data transfer techniques for a more efficient receipt of transferred data and subsequent forwarding of the data to the bank analyzer 106.

The bank analyzer data transfer framework 104 is operative to build normalized, business object-oriented data where the denormalized data is received from the business intelligence application. As described in further detail below, this denormalized data is processed using ETL operations, whereby the framework 104 includes a common functionality for the data components, thereby reducing processing overhead not only in the data being processed, but overhead by making the framework available with the different business intelligence applications 102.

As further illustrated in FIG. 1, the bank analyzer data transfer framework 104 thereby provides the now normalized data to the bank analyzer application 106. This normalized data is in a usable format, such that the analyzer application 106 may perform its known analytical operations. Not illustrated in FIG. 1, but described in further detail below, the bank analyzer application 106 provides feedback or other forms of reporting functionality to end users or other applications based on analyzing the data originally processed in front end systems and received by the business intelligence application.

FIG. 2 illustrates one exemplary embodiment of the bank analyzer data transfer framework 104. The framework 104 includes an extraction layer 120, a transformation component 122 and a data load device 124. The extraction layer 120 includes an extraction device 130 and an application data storage device 132. The transformation component 122 includes an extraction result component 134 with a data objects storage device 136, a transformation layer 138 with a data objects storage device 140 and a transformation result component 142 also with a data object storage device 144. The data load device 124 includes a data load layer 146, a source data storage device 148 and a result data storage device 150. These layers, components and devices may be implemented in hardware, software or a combination thereof. Additionally, the universal framework 104 may be disposed within the bank analyzer application 106 of FIG. 1 or within a common computing environment. In another embodiment, the framework may be ancillary to the business intelligence application 102 and the bank analyzer application 106, such as a middleware component.

In this embodiment, the extraction device 130 is in communication with the business intelligence application to extract the denormalized data. This data may be temporarily stored in the application data storage device 132. This extraction process may use known extraction techniques for retrieving the business intelligence data, thereby pulling data from various source systems. This data pull may be a full load or a delta load of a data object. The data is written into data store objects 136 in the extraction result layer 134 which represent data structure in the same way as they exist in the source system. The content of this layer is independent from the connection to the bank analyzer and could also be used for additional data transfer or computational purposes.

Regarding the transformation layer, the structure of business intelligence objects are similar to the objects received from a source data layer and a results data layer, where the source data layer and the results data layer may be components within the bank analyzer application. The transformation layer 138, including the temporary storage of data objects 140, includes the transformation of the format of the data from the denormalized structure to a normalized structure. This transformation may include conversion parameters as defined by the business intelligence application or by the front-end applications that supply the denormalized data to the business intelligence application. The denormalized data may include sub-levels of information in a structured format and the denormalization process includes removing the sub-layers of data and regenerating the data in a flat/normalized structure.

The transformation result component 142, in combination with the transformation layer 138, coordinates data objects 144 for the data load layer 146. The transformation results component 142 includes functionality for tracking status of data objects. In one embodiment, every object that is transformed into the transformation results data storage device 144 may include the result component 142 writing a record with a new status into a data monitoring component, where the status indicates that there is an update of an object in the transformation result of the business intelligence objects. This procedure may include more then one record for the same object, for example if the object was changed in its basis data and cash flow.

From the transformation layer 122 is the data load device 124 that is operative to load the data from the transformation layer 122 to the bank analyzer application. The load layer includes a data load layer 146 and two storage devices, storing source data 148 and result data 150. The data load layer 146 provides the data for being loaded to the bank analyzer application. The data load layer 146 may include communication with the bank analyzer application for a mapping format of transferring data thereto, including which data and possibly in which sequence, the now normalized data from the transformation layer 138, is provided to the bank analyzer application.

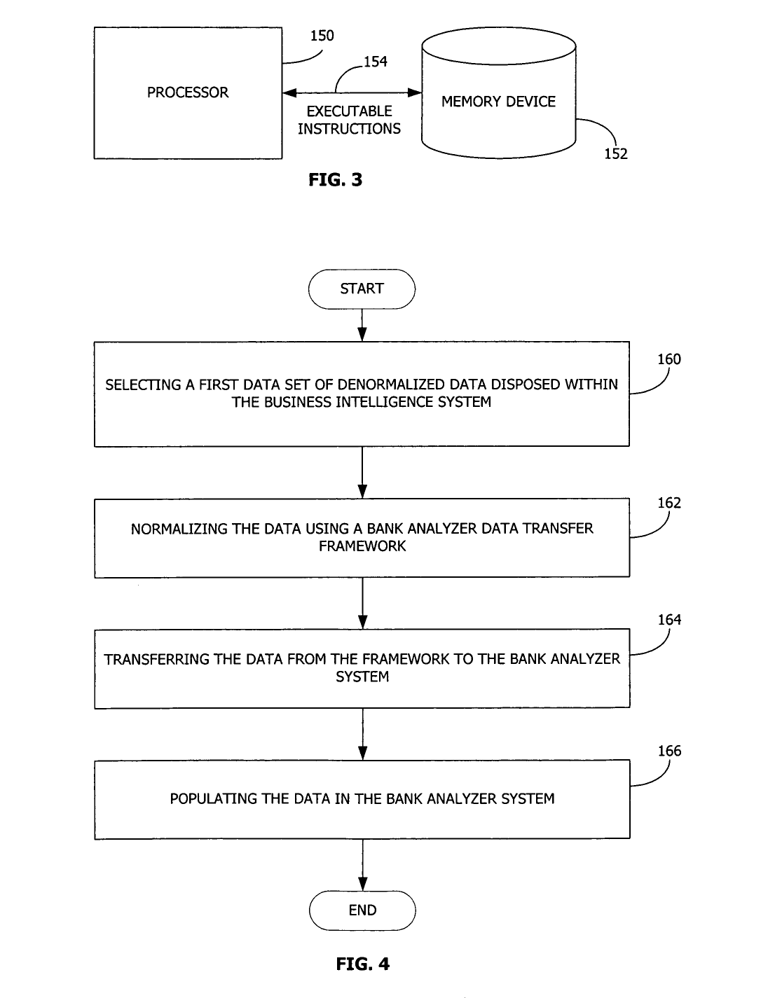

FIG. 3 illustrates one embodiment of an apparatus for integrating data from a business intelligence system to a bank analyzer system. The system 100 includes a processing 150 and a memory device 152. The memory device 152 includes executable instructions 154 stored therein, where these instructions 154 may be received and processed by the processing device 150. The processing device 150, in response to the executable instructions 154, is operative to perform various processing operations, including operations for integrating data from the business intelligence system to the bank analyzer system.

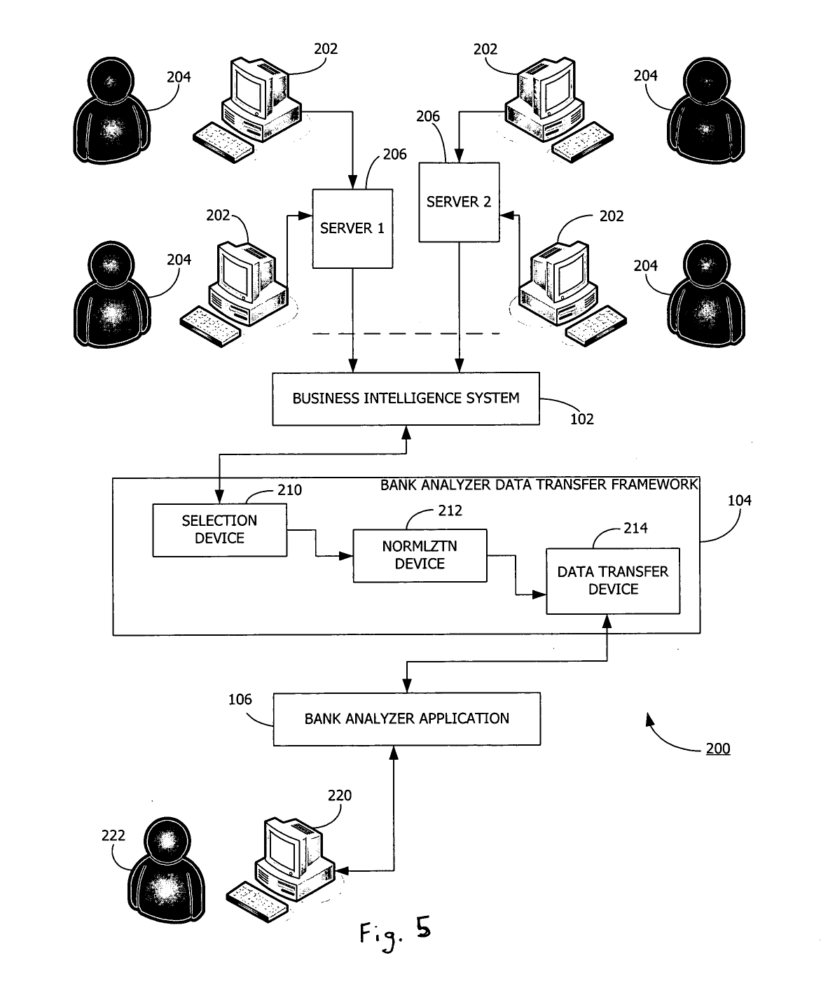

FIG. 4 illustrates a flowchart of the steps of one embodiment of a method for integrating data from a business intelligence system to a bank analyzer system. In one embodiment, the method begins, step 160, by selecting a first data set of denormalized data disposed within the business intelligence system. This data set may be selected from the business intelligence application 102.

The next step, step 162, is normalizing the data using a bank analyzer data transfer framework. This normalization may be performed by the universal bank analyzer 104, including operations as described in the above embodiment of FIG. 2.

The next step, step 164, is transferring the data from the framework to the bank analyzer system. This step may include data transfer operations by the data load layer 146 of FIG. 2 for transferring data to the bank analyzer application 106 of FIG. 1.

The next step, step 166, is populating the data in the bank analyzer system. The data load layer 146 of FIG. 2, including loading the normalized data into one or more data sets or formats such that the bank analyzer application may thereupon use the data, may also perform this data population. This above method provides the transfer of this data through the universal framework, allowing for the universal transfer of denormalized data from various front end systems or different business intelligence applications or systems to the bank analyzer application, allowing for further analysis of the front end financial data. Thereupon, in this embodiment, the method is complete.

FIG. 5 illustrates one embodiment of a system 200 including a plurality of front end computing devices 202, each of these devices including input and output components allowing for various users 204 to enter financial data. In a networked environment, the computing devices interact with servers 206. These servers 206 may allow for standard user input/output functionalities with known or typical front end computing systems, such as by way of example, an accountant entering financial information through a banking or financing application.

In the normal operation of the system 200, the servers 206 may be in communication with the business intelligence system 102. The servers 206 provide the financial information or other data to the business intelligence system using known or existing data transfer techniques, including any attendant formatting that may be associated with the business data objects, such as any denormalized structure for the data objects.

The universal framework 104 includes a selection device 210, a normalization device 212 and a data transfer device 214. These devices may be implemented in hardware, software or a combination thereof. These devices are operative to provide functionality allowing for the transmission and conversion of data from the business intelligence system 102 to the bank analyzer application 106. It is also recognized that the universal framework 104 may include additional components, which have been omitted here for clarity purposes only.

In the framework 104, the selection device 210 is operative to select a first data set of denormalized data disposed within the business intelligence system 102. This denormalized data may include data objects with sub-levels of data. Upon selection and receipt of the denormalized data, the normalization device 212 is operative to normalize the data. The normalization device 212 includes reducing the structured level to the data objects and generating a flat table of data.

Once the data is normalized, the data transfer device 214 is operative to transfer the normalized data to the bank analyzer application 106. This transfer may include the population of data into the bank analyzer application 106, including the writing or assembling of the normalized data into one or more predefined or common structures. This data population allows the bank analyzer application 106 to identify the received data and thereby perform one or more analytical operations thereon.

Within this system 200, the bank analyzer application 106 may also be in communication with another terminal or computing device 220. This device 220 may include receipt of the analytical computations, including providing an output to a user 222.

In other embodiments, the resultant computation performed by the bank analyzer application 106 may be provided to other suitable sources, such as being provided back to the business intelligence system 102, back to the servers 206 or even to various third party systems, such as an accounting system, reporting system or financial data monitoring system, for example.

In the system 200, as well as in the above-described systems of FIGS. 1-3 and the flowchart of FIG. 4, the universal framework 104 provides the ability to transfer and process data between any number of different business intelligence systems. Therefore, these embodiments may include the universal framework being in communication and transferring data from second, third or an n-numbered business intelligence system.

The universal framework 104 allows for the efficient transfer of data objects from the business intelligence system 102 to the bank analyzer application. Whereas previous techniques required customizable communication paths and data manipulation and transfer techniques for the various business intelligence and bank analyzer systems, the universal framework reduces this overhead. The universal framework allows the integrating of data from the business intelligence system to the bank analyzer system so that analytical operations on front-end information can be easily performed without additional resource requirements to transfer and manipulate the data between these systems.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. A method for integrating data from a business intelligence system to a bank analyzer system, the method comprising:
selecting a first data set of denormalized data disposed within the business intelligence system;
normalizing the data using a bank analyzer data transfer framework;
transferring the data from the framework to the bank analyzer system; and
populating the data in the bank analyzer system.

2. The method of claim 1 further comprising:
performing a data analysis operation on the data in the bank analyzer system.

3. The method of claim 1 further comprising:
selecting a second data set of denormalized data disposed within a second business intelligence system;
normalizing the second data using the bank analyzer data transfer framework;
transferring the second data from the framework to the bank analyzer system; and
populating the second data in the bank analyzer system.

4. The method of claim 3 further comprising:
performing a data analysis operation on at least one of: the data and the second data in the bank analyzer system.

5. The method of claim 1 wherein the bank analyzer data transfer framework is disposed external to the business intelligence system.

6. The method of claim 5 wherein the bank analyzer data transfer framework is a middleware component relative to the bank analyzer system.

7. The method of claim 1 wherein the data is a business object.

8. The method of claim 7 wherein the universal framework reduces an overhead computation load for an extraction, transformation, and load (ETL) process for the business object such that the business object provides a write interface with flat structures for writing objects into the bank analyzer system.

9. An apparatus for integrating data from a business intelligence system to a bank analyzer system, the apparatus comprising:
a selection device operative to select a first data set of denormalized data disposed within the business intelligence system;
a normalization device operative to normalize the data using a bank analyzer data transfer framework;
a data transfer device operative to transfer the data from the framework to the bank analyzer system; and
a population device operative to populate the data in the bank analyzer system.

10. The apparatus of claim 9 further comprising:
the selection device further operative to select a second data set of denormalized data disposed within a second business intelligence system;
the normalization device further operative to normalize the second data using the bank analyzer data transfer framework;
the data transfer device further operative to transfer the second data from the framework to the bank analyzer system; and
the population device further operative to populate the second data in the bank analyzer system.

11. The apparatus claim 9 wherein the bank analyzer data transfer framework is disposed external to the business intelligence system.

12. The apparatus of claim 11 wherein the bank analyzer data transfer framework is a middleware component relative to the bank analyzer system.

13. The apparatus of claim 9 wherein the data is a business object.

14. The apparatus of claim 13 wherein the universal framework reduces an overhead computation load for an extraction, transformation, and load (ETL) process for the business object such that the business object provides a write interface with flat structures for writing objects into the bank analyzer system.

15. A data integrating system comprising:
a business intelligence system having a plurality of data sets of denormalized data;
a bank analyzer data transfer framework disposed external to the business intelligence system operative to receive one or more selected data sets of denormalized data from the business intelligence system and the framework further operative to normalize the data; and
a bank analyzer system operative to receive the normalized data from the framework and populate the normalized data therein.

16. The system of claim 15 wherein the bank analyzer system is further operative to perform a data analysis operation on the normalized data stored therein.

17. The system of claim 15 further comprising:
a second business intelligence system having a plurality of second data sets of denormalized second data; and
the bank analyzer data transfer framework further operative to normalize the second data and transfer the normalized data to the bank analyzer system.

18. The system of claim 15 wherein the bank analyzer data transfer framework is a middleware component relative to the bank analyzer system.

19. The system of claim 15 wherein the data is a business object.

20. The system of claim 19 wherein the universal framework reduces an overhead computation load for an extraction, transformation, and load (ETL) process for the business object such that the business object provides a write interface with flat structures for writing objects into the bank analyzer system.
